(19) United States
(12) Patent Application Publication
(10) Pub. No.: US 2014/0195287 A1
(43) Pub. Date: Jul. 10, 2014

(54) GESTURE BASED ELECTRONIC SIGNATURE

(71) Applicant: Christopher Ian Fraser, Ottawa (CA)

(72) Inventor: Christopher Ian Fraser, Ottawa (CA)

(21) Appl. No.: 12/545,553

(22) Filed: Aug. 21, 2009

(51) Int. Cl. G06Q 10/00; G06Q 10/06

(52) U.S. Cl. 705/7.15; 705/7.14

(57) ABSTRACT

A business process management application provides a gesture based signature, and approval mechanism that associates a reply or assent from a remote device with the business process that sent it, thus providing assurances that the resulting approval or disapproval was properly obtained and records the reply for future accountability. A context identifier indicative of the business process that initiated the interactive request for action (action typically being approval, disapproval or acknowledgment) is generated, encoded to discourage tampering, and appended to the interactive request sent to the remote device. The reply received in response to the interactive request thus bears the context identifier allowing the received reply to be correlated to the business process that initiated it and stored for providing an audit trail.

### BACKGROUND

The rapid technological advancement in information processing over the last several decades has greatly changed the workflow in a typical business environment. Tasks formerly performed on paper and executed via manual delivery have evolved into electronic forms and email. As part of this evolution, software applications for business process management have codified typical business workflows in a scalable manner such that a consistent screen-based GUI (graphical user interface) and standardized exchange of emails and events replace paper mechanisms in many business environments. Concurrently, network technology has made such business process management available to multiple employees at various locations. A conventional business process, therefore, is performed as a consistent set of on-screen forms and email-type exchanges, thus increasing efficiency through procedural consistency and elimination of paper workflow exchanges.

However, the rapid advancement of user computing devices has led to a wide range of user rendering devices through which users and/or employees interact. A complex process management application may be designed for a limited number of rendering devices, such as PCs and/or remote terminals. Conventional process management applications may expect certain functionality and/or resources at a rendering device. Remote users, however, have a plethora of equipment options available, from enhanced cellphones with minimalistic browser capabilities, to well equipped PDAs with moderate GUI capability, and high end laptops comparable in performance to a well equipped desktop. Remote users may therefore encounter inconsistent or erratic results when attempting to remotely interact with a business process management application.

### SUMMARY

Business process management applications are increasingly challenged by demands for greater remote connectivity. As modern “telecommuting” trends drive dependency on technology for providing secure, high speed, and reliable remote connections, business process management applications need to adapt to remote employee activity. Business process management typically defines a set of steps, or actions, that occur in a regular manner during a normal course of business. Often, employees must take action by either confirming or responding at particular steps in the business process. For example, a typical meeting invite allows one to confirm or deny attendance, and allows specification of an alternative time if declined. Other actions which require assent from an employee often concern expenditures, such as purchase orders (POs) and hiring requisitions. In a business process context, accountability is typically tied to such approvals. Non-repudiation, or validation, of such approvals is desirable because it prevents misunderstanding or ambiguity in the approval process.

Unfortunately, conventional business process management applications suffer from the shortcoming that support for remote devices often may be lacking, thus remote users find their devices unable to handle the business process application and associated exchanges. Many so-called “lightweight” devices, such as PDAs and screen equipped cellphones, cannot display a full suite of HTML page artifacts, and cannot display online forms such as PDF based screens. Often, even an email display is pared down from its full screen counterpart. Accordingly, configurations herein are based, in part, on the observation that employees interacting with a business process management application from a remote location often are unable to invoke features of the application, such as offering assent to a interactive request for approval/disapproval. This prevents the business process thread from completion until the assenting employee returns to the business process context (i.e. main office) or acquires a suitably conversant device, such as a VPN enable PC.

Accordingly, configurations disclosed herein substantially overcome the shortcomings of remote interaction with conventional business process management applications by providing a gesture based signature, or approval, mechanism that associates a reply or assent from a remote device with the business process that sent it, thus providing assurances that the resulting approval or disapproval was properly obtained and recording the reply for future accountability. A context identifier indicative of the business process that initiated the interactive request for action (action typically being approval, disapproval or acknowledgment) is generated, encoded to discourage tampering, and appended to the interactive request sent to the remote device. The reply received in response to the interactive request also bears the context identifier allowing the received reply to be correlated to the business process that initiated it, and the reply is also stored to provide an audit trail. Such business process management operations may be delivered in conjunction with products such as Adobe® LiveCycle® Enterprise Suite, marketed commercially by Adobe Systems Incorporated, of San Jose, Calif.

While conventional approaches may suggest an email reply be used as an indicator of assent, some typical email systems may not integrate a tag or identifier to indicate the context from which an email was sent. Generic emails are not recognized as control information by the business process management application, and cannot provide the context identifier indicative of the initiating business process for automatic reconciliation. In other words, the remote device provides a reply or response that is recognized by the business process management application as though it was entered locally at a full function device (i.e. PC), but without requiring the assenting employee to be onsite or within a VPN which may require substantially more hardware and computational overhead.

In further detail, the method for gesture based signatures as defined herein includes generating a context identifier, such that the context identifier corresponds to a business process context maintaining a set of business processes, and transporting an interactive request to a remote device, in which the remote device is networked outside the business process context. The interactive request invites or expects an accountable response on behalf of a business process, and the sending business process appends the context identifier to the interactive request. Upon receiving a reply to the interactive request from the remote device, in which the reply includes the appended context identifier, the system correlates, using the context identifier, the received reply with the transported interactive request that initiated the received reply to verify a match, thus determining the user corresponding to the received reply.

In the business process management application, each business process (process) defines a series of actions and exchanges, in which the actions define a task for completion, and the exchanges define assent to commencement or completion of an action in the task via the interactive request. The application obfuscates the context identifier such that values in the context identifier are not ascertainable by inspection and modification by the typical user. The context identifier typically includes a task ID, an action ID, and a process ID, the action ID denoting an accountable item to which a personal assent is expected via the interactive request, thus identifying the business process, task, and step (action) that it is responsive to. To maintain uniqueness and determinism of the context identifiers, the business process management application increments the action ID upon resolution of each step within the task, increments the task ID upon completion of the task, and identifies a new process ID upon commencement of a new business process.

The business process context therefore defines a set of computing entities coupled so as to maintain process independence and common storage such that each of multiple business processes operate distinct from other business processes and each is accessible from within the context, and in which each business process corresponds to one or more executable entities. The business process management application also maintains a repository of the context identifiers for reconciling received replies with the process, task and action to which it corresponds.

Alternate configurations of the invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a managed information environment suitable for use with the present configuration;

FIG. 2 is a flowchart of a business process management application in the environment of FIG. 1;

FIG. 3 is a block diagram of an example business process workflow according to the business process management application of FIG. 2; and

FIGS. 4-6 are a flowchart of operation of the business process management application depicted in FIG. 3.

### DETAILED DESCRIPTION

The approaches depicted below disclose implementations of the gesture based electronic signatures summarized above. The disclosed arrangements depict the business process application performing a purchase order process sequence using the gesture based system disclosed herein. Remote rendering devices operated by authorizing employees issue an authenticated (e.g. signature based) approval in which an email response defines the signature gesture authorizing, or indicating assent to, the requested action. The interactive request and reply take the form of an email, however could be any suitable event or form operable for rendering and receiving the input gesture on the particular user device.

The following approaches disclosed herein provide a seamless interface back into the business process management application. In contrast to conventional email, the context identifier provides an automated reconciliation and validation of related items and responses. Emails provide a textual response, but provide no correlation to the message which originated them, as in the interactive requests disclosed herein. Although an email reply may optionally include the text of the precipitating message, this is a data manipulation, not a control aspect, since the text is simply copied. For example, a manual search operation is required to identify an outgoing email triggering an incoming response, usually by searching for a common originator or subject.

Other conventional systems, such as Majordomo (greatcircle.com/majordomo), automate the management of Internet mailing lists. Commands are sent to Majordomo via electronic mail to handle all aspects of list maintenance. Once a list is set up, subsequent operations can be performed remotely by email, requiring no intervention upon the postmaster of the list site. However, while Majordomo suggests the concept of issuing commands via email, in the disclosed approach the received reply to the interactive request contains information from the system that positively identifies the task that the reply is associated with, and the reply (email or otherwise) is retained to be used as the signature of the user authorizing the system to perform the action. The Majordomo approach applies no contextual information to the executed commands sent via email.

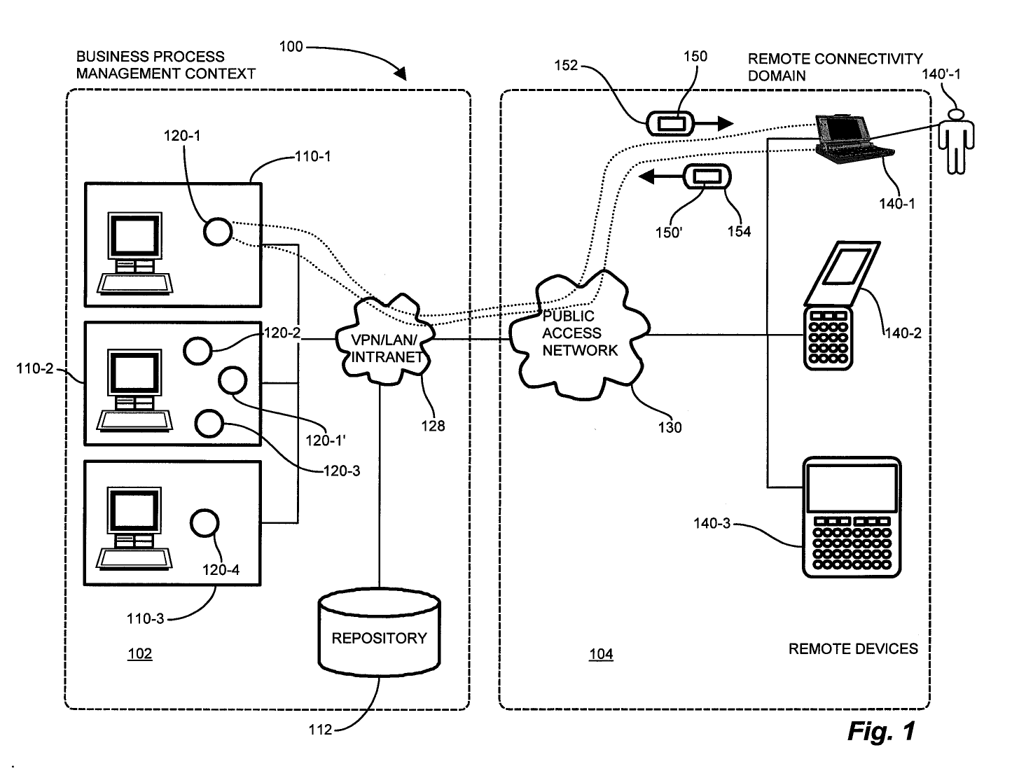

FIG. 1 is a context diagram of a managed information environment suitable for use with the present configuration. Referring to FIG. 1, a managed information environment 100 includes a business process context 102 and a remote connectivity domain 104. The business process context 102 is a tightly coupled environment having common storage capability among a plurality of user nodes 110-1 . . . 110-3 (110 generally) in a VPN, LAN or intranet 128 setting, for example. Business processes 120-1 . . . 120-4 (120 generally) operate on the nodes 110, typically as one or more executable entities. For example, business process 120-1 and 120-1′ on nodes 110-1 and 110-2, respectively, represent such a distributed process. The business processes 120 are not necessarily bound by executable entities, as particular business process 120 may comprise several executable entities, while a particular executable entity may be performing multiple tasks.

The remote connectivity domain 104 is accessed via an interface 127 to the Internet 130 or other suitable public access network. Remote devices 140-1 . . . 140-3 (140 generally) accessible via the public access network 130 such as the Internet include laptop 140-1, cellphone 140-2 and PDA 140-3, however any suitable communication device may be employed, discussed further below. The remote connectivity devices 140 do not have direct computational links to the business process context 102, but rather must interact via remote messaging such as email. Due to their lightweight nature, typically because of limited VPN, email, or forms capability, the remote devices 140 cannot directly access a context identifier 150 within requests and replies 152, 154 corresponding to the business process 120 requesting a reply. For example, a laptop 140-1 may only have email capability, or a cellphone 140-2 may not support a robust set of forms which the corresponding business process emanates.

Within the business process context 102, a context identifier 150 indicative of a business process 120 is accessible by other nodes 110. However, when an interaction with remote nodes 140 occurs, the context identifier 150 is not ordinarily accessible. A context identifier 150 including a concatenation of a process ID, Task ID and action ID (discussed further below) is included with an interactive request 152 outside the business process context 102. The context identifiers 150 are stored in a repository 112 accessible to the nodes 110. When the recipient sends a reply 154 to the interactive request 152, the context ID 150′ is returned so that the originating business process may reconcile it with the interactive request 152 it is responsive to. The context identifier 150, 150′ is obfuscated, such as by B64 encoding, sufficient to prevent a casual user from identifying the values of the context identifier from mere inspection. It should be noted that, although the interactive request 152 and reply 154 may be email or a application specific message, they are in either case under the control of the sending process 120, and thus integrated with the context identifier, in contrast to standalone email which has not integrated or embedded context ID.

For example, suppose a manager is away from the office and cannot access a node 120 within the business process context 102. Meanwhile, a human resources employee is processing a bonus for one of the manager's staff, and needs to confirm the manager's approval. The business process 120 processing the bonus employs PDF forms, but the manager has only a PDA that does not support such forms. Under conventional mechanisms, the PDA would be unable to generate an adequate response, however, the business process 120 generates a message (such as an email) readable by the PDA which has the context identifier 150. This avoids need for complex forms which may be unavailable on smaller devices having limited display capabilities. The manager replies to the interactive request and approves the bonus, and the reply includes the context identifier 150′ to correlate approval and substantiate the manager's action. The business process 120-1 tracks the incoming reply 154 by matching the incoming context identifier 150′ with the context identifier 150 of the outgoing interactive request 152.

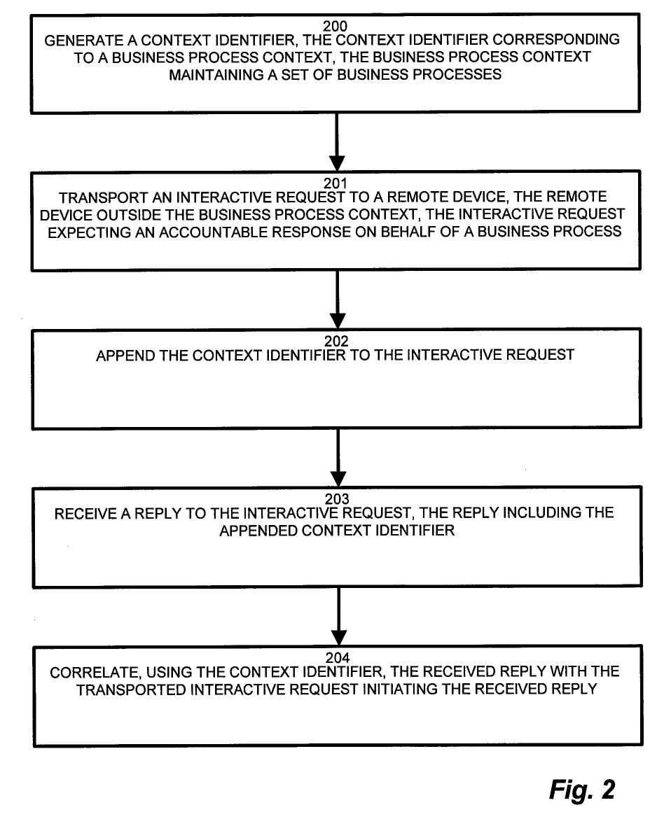

FIG. 2 is a flowchart of a business process management application in the environment of FIG. 1. Referring to FIGS. 1 and 2, a particular configuration of the method for gesture based signatures includes, at step 200, generating a context identifier 150, such that the context identifier 150 corresponds to a business process context 102, in which the business process context 102 maintains a set of business processes 120. The business process context 102, in the example shown, executes a process management application having multiple business processes 120-N, each of which executes tasks having actions, or steps. Task delegation initiates an event, an event triggers an email or other interactive request 152 to a responsible person, such that the email is configured to generate a reply 154 responsive to the task delegation (i.e. contains the context identifier and other control information). Upon an application instruction triggering an authenticated response (i.e. authorization from a user), the process 120 transports an interactive request 152 to a remote device 140, in which the remote device 140 is outside the business process context 102, as depicted at step 201. The interactive request 152 expects an accountable response 154 on behalf of the business process 120; the generated context identifier 150 identifies the originator (process, task and action) of the interactive request. Conventional interactive requests 152 originate and terminate only at nodes 110 within the business process context 102, such that the originating process 120, task, and action are readily ascertainable. In contrast, upon communication outside the business process context 102, the context identifier 150 is not available, hence configurations herein define the interactive request 152 to preserve the context identifier 150.

The process 120 appends the context identifier 150 to the interactive request 152 for transmission to the remote device 140, as depicted at step 202, and the request 152 is acted upon by the user/recipient 140′ at the remote device 140. The sending process 120 then receives a reply 154 to the interactive request 152, in which the reply includes the appended context identifier 150 from the outgoing interactive request 152, as disclosed at step 203. The process 120 correlates, using the context identifier 150, the received reply 154 with the transported interactive request 152 initiating the received reply 154, as depicted at step 204.

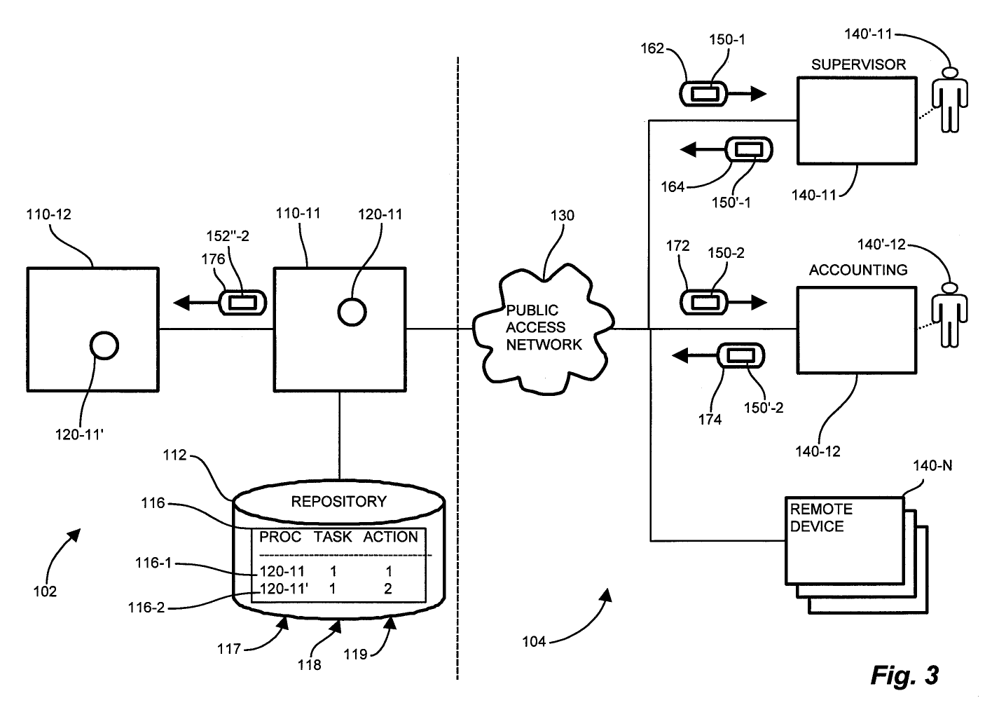

FIG. 3 is a block diagram of an example business process workflow according to the business process management application of FIG. 2. Referring to FIGS. 1 and 3, FIG. 3 shows an example approval process for a purchase order (PO) business process 120-11. In this example, an employee has requisitioned a new laptop, and the supervisor must approve the purchase, followed up by accounting acknowledging responsibility to pay the vendor. The PO business process 120-11, on node 110-11 within the business process context 102, generates an interactive request 162 to the supervisor 140-11, requesting approval and having context identifier 150-1. The repository 112 has a context table 116 for storing the context identifiers 150, and creates entry 116-1 for task 1, action 1 corresponding to the interactive request 162. The supervisor approves the PO and responds with reply 164 having context identifier 150′-1, received back at the business process 120-11 for correlation with entry 116-1.

Having received approval by the supervisor 140-11, accounting needs to acknowledge payment, so the business process 110-11 sends an interactive request 172 to the accounting representative 140-12. Interactive request 172 includes context identifier 150-2, corresponding to task 1, action 2, as shown by entry 116-2. The accounting representative, using device 140-12, acknowledges payment of the PO, and initiates reply 174, having context identifier 150′-2. Upon receipt back at business process 120-11, node 110-11 sends a request 176 to cut a check to node 110-12, on which business process 120-11′ resides. Business process 120-11′ may then validate the check request 176 using the context id 150″-2 and confirm that the approval was given by the accounting rep 140-12 as task 1, action 2 of the business process.

Further, it should be noted that the techniques described herein may be implemented by various components of a computer system configured to provide the functionality described. As discussed above with respect to FIGS. 1 and 3, the disclosed arrangement illustrates one embodiment of a business process context 102, business processes 120, such as software modules and connected components configured to implement the methods described herein. In different embodiments, the environment 100 may include any of various types of devices, including but not limited to a personal computer (PC), desktop computer, laptop, notebook or netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device.

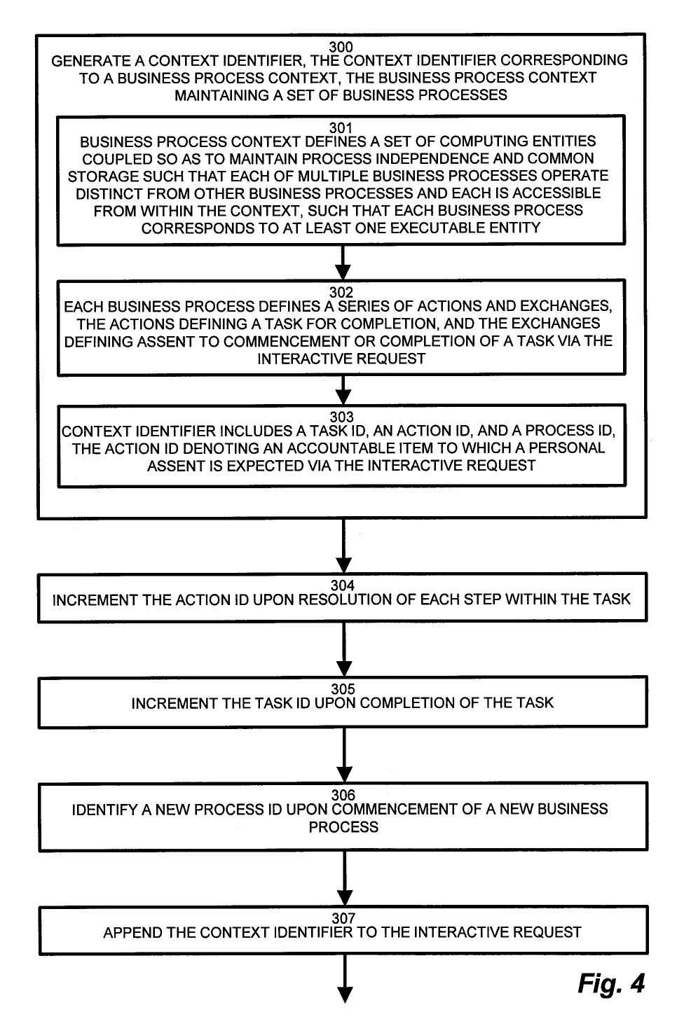

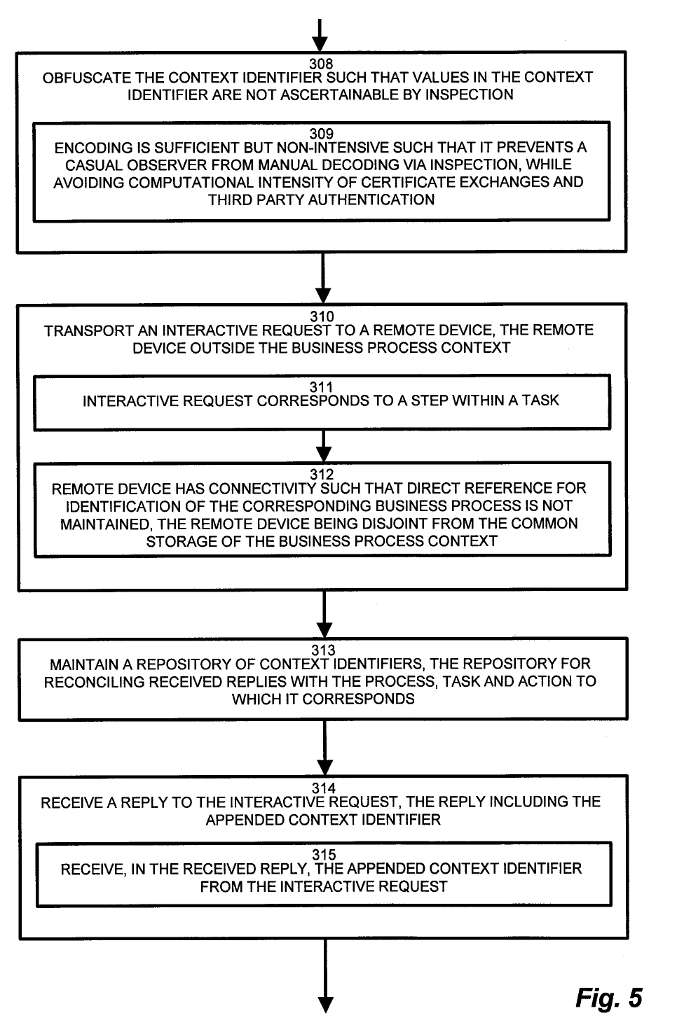

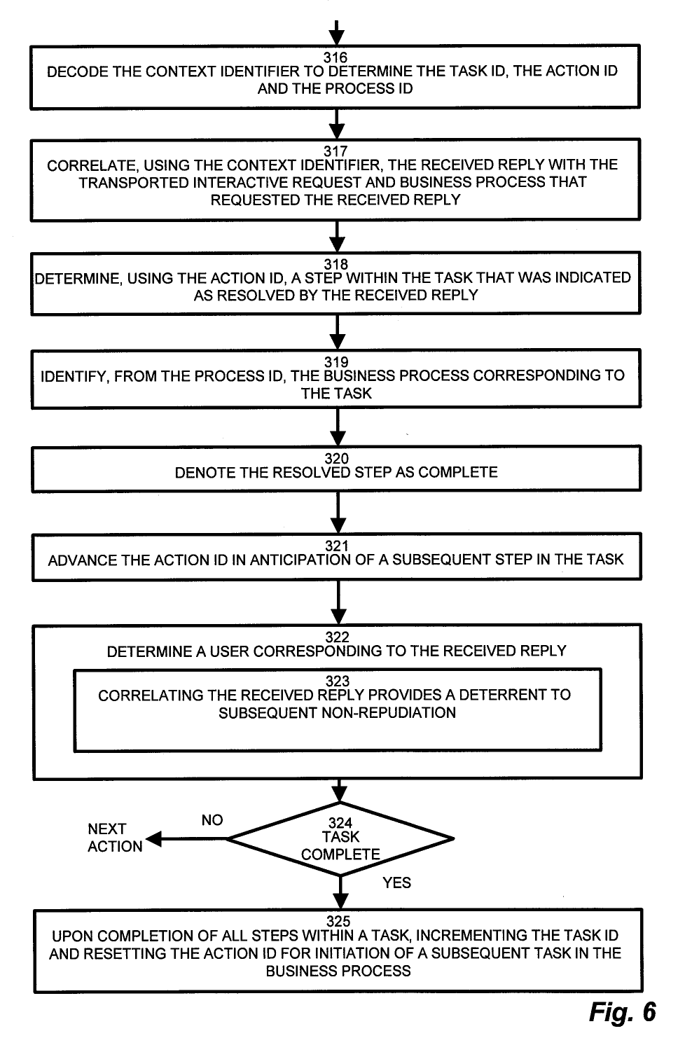

FIGS. 4-6 are a flowchart of operation of the business process management application depicted in FIG. 3. Referring to FIGS. 3-6, a task in progress generates the context identifier 150 corresponding to a business process context 102 maintaining a set of business processes, as depicted at step 300. The business process context 102 defines a set of computing entities 100, or nodes, coupled so as to maintain process 120 independence and common storage such that each of multiple business processes 120-N operate distinct from other business processes and each is accessible from within the context 102, such that each business process 120 corresponds to at least one executable entity, as shown at step 301. Each business process 120 defines a series of actions and exchanges, in which the actions define a task for completion, and the exchanges, such as interactive request 152 and corresponding response 154, define assent to commencement or completion of a task via the interactive request 152, as disclosed at step 302. In the example arrangement shown, the context identifier includes a task ID, an action ID, and a process ID, in which the action ID denotes an accountable item to which a personal assent is expected via the interactive request 152, as depicted at step 303. Other forms of the context identifier may be employed. Typically the personal assent is acknowledgement of a delegation, or approval or disapproval of a request by a user/recipient. Such assent is recorded via the context identifier 150 in the repository 112 for maintaining an audit trail and accountability of actions taken.

The sending process 120 increments the action ID upon resolution of each step within the task, as shown at step 304, as tasks typically include a plurality of actions performed as sequential steps. Likewise, the process increments the task ID upon completion of the task, as depicted at step 305, and the business process application identifies a new process ID upon commencement of a new business process, as disclosed at step 306. In the operation of the business process management application employed as an example, the context identifier includes a task ID, action ID, and a process ID, such that the task ID is incremented each task, the action ID indicates steps within the task, and the process ID denotes a business process. In this manner, the context identifiers 150 are maintained unique and specific to the process 120, task and action to which they correspond.

Upon transmission to the remote node 140, the business process 120 appends the context identifier 150 to the interactive request 152, as depicted at step 307, and obfuscates the context identifier 150 such that values in the context 150 identifier are not ascertainable by inspection, as shown at step 308. Thus, the obfuscated values are transformed and either not visible or may appear as garbled or an unordered text string, or may otherwise not be visible in the rendered message body. Due to the nature of the system, while third party authentication and encryption could be performed on the context identifier, such security would inject additional overhead and require that the remote devices were enabled with certificates supporting the authentication and key exchange. This computational demand would tend to defeat the lightweight, efficient nature of the context identifier 150 exchange using the interactive request 152 and resulting response 154. Thus, the encoding is selected to be sufficient but non-intensive such that it prevents a casual observer from manual decoding via inspection, while avoiding computational intensity of certificate exchanges and third party authentication, as disclosed at step 309. In the example arrangement, B64 encoding, as is known in the art, may be employed, however any suitable encoding scheme may also be employed.

The process 120 transports the interactive request 152 to the remote device 140-1, in which the remote device 140-1 is outside the business process context 102, as shown at step 310. The interactive request corresponds to a step within a task, as depicted at step 311 and shown by table 116. In the remote connectivity domain 104, the remote device 140 has connectivity such that direct reference for identification of the corresponding business process 120 may not be maintained, in which the remote device 140 is disjoint from the common storage 112 of the business process context 102, as disclosed at step 312.

The business process context 102 maintains the repository 112 of context identifiers 150, such that the repository 112 and table 116 are configured for reconciling the received replies 152 with the process 120, task and action to which it corresponds, as disclosed at step 313.

The process 120 receives a reply 154 to the interactive request, such that the reply includes the appended context identifier 150′, as depicted at step 314. The process 120 thus retrieves, from the received reply 154, the appended context identifier 150′ copied or transferred from the interactive request 152, as clarified at step 315. The receiving process 120 decodes the context identifier 150′ to determine the task ID, the action ID and the process ID, as shown at step 316, and correlates, using the context identifier 152′ and table 112, the received reply 154 with the transported interactive request 152 and business process 117 that requested the received reply 154, as depicted at step 317. The process 120 determines, using the action ID 119 in the entry 116-N, a step within the task that was indicated as resolved by the received reply 154, as shown at step 318, and identifies, from the process ID, the business process 120 corresponding to the task 118, as depicted at step 319. The process denotes the resolved step 119 as complete; and advances the action ID 119 in anticipation of a subsequent step in the task, as depicted at steps 320 and 321, respectively.

The entry 116-N is employed to determine the user 140′ corresponding to the received reply 154, as disclosed at step 322, such that correlating the received reply provides a deterrent to subsequent non-repudiation via the resulting audit trail, as depicted at step 323. A check is performed, at step 324, to determine if the task 118 is complete or if more steps (actions) 119 are required, and upon completion of all steps 119 within a task, system increments the task ID and resets the action ID for initiation of a subsequent task in the business process 120, as depicted at step 325.

Those skilled in the art should readily appreciate that the programs and methods for gesture based electronic signatures as defined herein are deliverable to a user processing and rendering device in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a set of software executable objects or modules, or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and method for gesture based electronic signatures has been particularly shown and described with references to embodiments thereof, it will be understood by those skilled in the art that various changes in form and details may be made therein without departing from the scope of the invention encompassed by the appended claims.

What is claimed is:

1. A computer-implemented method comprising:
performing by a business process management application executed by at least one electronic processor the following:
determining an action of a business process to be completed at a remote device instead of at a device within a local business process context, the business process executed within the local business process context, and wherein the remote device lacks direct computational access to the local business process context;
generating a context identifier, the context identifier corresponding to the business process context and the action;
generating an email and appending the context identifier to the email, the email configured to request approval for an requested action of the business process;
transmitting the email to the remote device;
receiving a reply to the email from the remote device, the reply including the context identifier and a gesture-based signature, the reply comprising a reply email indicating approval of the requested action,
correlating the received reply with the email using the context identifier and the gesture-based signature; and
marking the action complete.

2. The method of claim 1, wherein each business process further defines a series of actions and exchanges, the actions defining a task for completion, and the exchanges defining assent to commencement or completion of an action in the task via the interactive request.

3. The method of claim 1 further comprising encoding, by the business process management application, the context identifier such that values in the context identifier are transformed.

4. The method of claim 1 wherein the context identifier includes a task ID, an action ID, and a process ID, the action ID denoting the action, further comprising:
incrementing, by the business process management application, the action ID upon resolution of the action;
incrementing, by the business process management application, the task ID upon completion of the task; and
identifying, by the business process management application, a new process ID upon commencement of a new business process.

5. The method of claim 1 wherein the business process context defines a set of computing entities coupled so as to maintain process independence and common storage such that each of multiple business processes operate distinct from other business processes and each is accessible from within the context, such that each business process corresponds to at least one executable entity.

6. The method of claim 1 further comprising maintaining, by the business process management application, a repository of context identifiers, the repository storing data for reconciling received replies with a process, task and action to which the respective reply corresponds.

7. The method of claim 6 wherein the context identifier includes a task ID, action ID, and a process ID, such that:
the task ID indicates a task;
the action ID indicates the action; and
the process ID denotes a business process.

8. The method of claim 7 wherein the interactive request corresponds to the action, further comprising:
decoding, by the business process management application, the context identifier to determine the task ID, the action ID and the process ID;
determining, by the business process management application and using the action ID, the action;
identifying, by the business process management application and using the process ID, the business process corresponding to the task; and
advancing, by the business process management application, the action ID.

9. The method of claim 8 further comprising, upon completion of all steps within the task, incrementing, by the business process management application, the task ID and resetting the action ID for initiation of a subsequent task in the business process.

10. The method of claim 3 wherein the encoding is configured to obfuscate the context identifier, but is not configured to perform certificate exchanges and third party authentication.

11. (canceled)

12. (canceled)

13. An apparatus comprising:
a processor and a memory, the processor configured to execute a business process management application by executing business processes;
at least one business process configured to:
determine an action of a business process to be completed at a remote device instead of at a device within a local business process context, the business process executed within the local business process context, and wherein the remote device lacks direct computational access to the local business process context;
generate a context identifier, the context identifier corresponding to the business process context and the action, and
generate an email and append the context identifier to the email, the email configured to request approval for an requested action of the business process;
a network interface configured to:
transmit the email to the remote device, and
receive a reply to the email, the reply including the context identifier and a gesture-based signature, the reply comprising a reply email indicating approval of the requested action; and
a repository having information for correlating, using the context identifier and the gesture-based signature, the received reply with the email,
the business process management application further configured to mark the action complete.

14. The apparatus of claim 13 wherein each business process in the memory of the business process management application defines a series of actions and exchanges, the actions defining a task for completion, and the exchanges defining assent to commencement or completion of an action within the task via the interactive request.

15. The apparatus of claim 14 wherein the context identifier includes a task ID, an action ID, and a process ID, the action ID denoting the action, the processor further configured to:
increment the action ID upon resolution of the action associated with the reply;
increment the task ID upon completion of the task; and
identify a new process ID upon commencement of a new business process.

16. The apparatus of claim 14 wherein the business process context defines a set of computing entities coupled so as to maintain process independence and common storage such that each of multiple business processes operate distinct from other business processes and each is accessible from within the business process context, such that each business process corresponds to at least one executable entity.

17. The apparatus of claim 14 wherein the business process management application is configured to maintain the repository.

18. The apparatus claim 17 wherein the interactive request corresponds to a step within a task, and further comprising:
a decoder module configured for decoding the context identifier to determine the task ID, the action ID and the process ID, and
wherein the at least one business process is further configured to:
determining, using the action ID, the action associated with the received reply;
identifying, from the process ID, the business process corresponding to the task; and
advancing the action ID.

19. The apparatus of claim 21 wherein the encoder module is configured to obfuscate the context identifier, but is not configured to perform certificate exchanges and third party authentication.

20. A computer program on a non-transitory computer readable storage medium encoded as a set of processor based instructions that, upon execution by a processor, cause the processor to:
determine an action of a business process to be completed at a remote device instead of at a device within a local business process context, the business process executed within the local business process context, and wherein the remote device lacks direct computational access to the local business process context
generate a context identifier, the context identifier corresponding to the a-business process context and the action;
generate an email and append the context identifier to the email, the email configured to request approval for an requested action of the business process;
transmit the email to the remote device;
receive a reply to the email, the reply including the context identifier and a gesture-based signature, the reply comprising a reply email indicating approval of the requested action;
correlate, using the context identifier and the gesture-based signature, the received reply with the email and a business process that initiated the email; and
mark the action complete.

21. The apparatus of claim 13, further comprising an encoder module configured to obfuscate the context identifier such that values in the context identifier are transformed.

22. The computer program of claim 20 further comprising instructions that cause a processor to obfuscate the context identifier such that values in the context identifier are transformed.
